(19) United States
(12) Patent Application Publication
(10) Pub. No.: US 2010/0070490 A1
(43) Pub. Date: Mar. 18, 2010

(54) SYSTEM AND METHOD FOR ENHANCED SMART PLAYLISTS WITH AGGREGATED MEDIA COLLECTIONS

(75) Inventors: Christopher M. Amidon, Apex, NC (US); Harold Sutherland, San Jose, CA (US); Hugh Svendsen, Chapel Hill, NC (US)

Correspondence Address: WITHROW & TERRANOVA CT, 100 REGENCY FOREST DRIVE , SUITE 160, CARY, NC, 27518, US

(73) Assignee: ELOY TECHNOLOGY, LLC, WILMINGTON, DE (US)

(21) Appl. No.: 12/211,895

(22) Filed: Sep. 17, 2008

(51) Int. Cl. G06F 17/30

(52) U.S. Cl. 707/722; 707/E17.009

(57) ABSTRACT

A method and system are disclosed for providing a smart playlist in a media sharing system. In one embodiment, a user of a user device participates in a media sharing system wherein a media collection of the user is aggregated with one or more shared media collections to provide an aggregate media collection of the user. The user device of the user obtains a playlist definition for a smart playlist. Based on the playlist definition, the smart playlist is populated from the aggregate media collection of the user.

### RELATED APPLICATIONS

This application is related to U.S. patent application Ser. No. ______, entitled SYSTEM AND METHOD FOR MANAGING A PERSONALIZED UNIVERSAL CATALOG OF MEDIA ITEMS, which was filed on Sep. 17, 2008 and is hereby incorporated herein by reference in its entirety.

### FIELD OF THE INVENTION

The present invention relates to smart playlists.

### BACKGROUND OF THE INVENTION

The Apple iTunes® media player enables users connected on a Local Area Network (LAN) to share their media collections with one another. One issue is that when a first user accesses media items shared by another user, personalized metadata is not available. There is no capability to personalize shared media items by maintaining personalized metadata such as, for example, usage statistics, user ratings, or the like for the shared media items. As such, there is a need for a system and method for maintaining personalized metadata for media items shared in media sharing system. Another issue is that shared playlists are static and cannot be personalized with respect to the user with which the playlists are shared. As such, there is also a need for a system and method for personalizing shared playlists in a media sharing system.

### SUMMARY OF THE INVENTION

The present invention relates to a smart playlist in a media sharing system. In one embodiment, a user of a user device participates in a media sharing system wherein a media collection of the user is aggregated with one or more shared media collections to provide an aggregate media collection of the user. The user device of the user obtains a playlist definition for a smart playlist. Based on the playlist definition, the smart playlist is populated from the aggregate media collection of the user.

In one embodiment, personalized metadata is maintained for the media items in the aggregate media collection. The personalized metadata for a media item in the aggregate media collection may include personalized metadata for the user of the user device, personalized metadata for one or more other users that are participating or have participated in the media sharing system, or both. In this embodiment, the playlist definition for the smart playlist includes one or more media criteria such as, for example, one or more genres, one or more artists, one or more albums, one or more time periods, or the like. In addition, the playlist definition for the smart playlist includes one or more user criteria such as, for example, a threshold user rating value, a range of user rating values, a time period in which desired media items for the smart playlist were last played, a threshold play count value, a range of play count values, or the like. Still further, the one or more user criteria may include information identifying a user whose personalized metadata for media items in the aggregate media collection is to be used when populating the smart playlist, information identifying a number of users whose personalized metadata may be used when populating the smart playlist and a priority of each of the number of users, or the like.

Those skilled in the art will appreciate the scope of the present invention and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the invention, and together with the description serve to explain the principles of the invention.

FIG. 1 illustrates a media sharing system in which personalized metadata is maintained according to one embodiment of the present invention;

FIGS. 2A and 2B illustrate an exemplary embodiment of a universal catalog;

FIG. 3 illustrates the operation of the media sharing system of FIG. 1 according to one embodiment of the present invention;

FIGS. 4A through 4C graphically illustrate the operation of the media sharing system of FIG. 1 via an exemplary Graphical User Interface (GUI) according to one embodiment of the present invention;

FIG. 5 is a flow chart illustrating a process for aggregating universal catalogs according to one embodiment of the present invention;

FIG. 6 is a flow chart illustrating a process for aggregating universal catalogs according to another embodiment of the present invention;

FIG. 7 is a flow chart illustrating a process for maintaining a universal catalog according to another embodiment of the present invention;

FIG. 8 is a flow chart illustrating a process for obtaining and populating a smart playlist according to one embodiment of the present invention;

FIG. 9 illustrates an exemplary GUI enabling a user to define or configure a smart playlist definition according to one embodiment of the present invention;

FIGS. 10A through 10C illustrate an exemplary use case according to one embodiment of the present invention; and

FIG. 11 is a block diagram of one of the user devices of FIG. 1 according to one embodiment of the present invention.

### DETAILED DESCRIPTION OF THE PREFERRED EMBODIMENTS

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

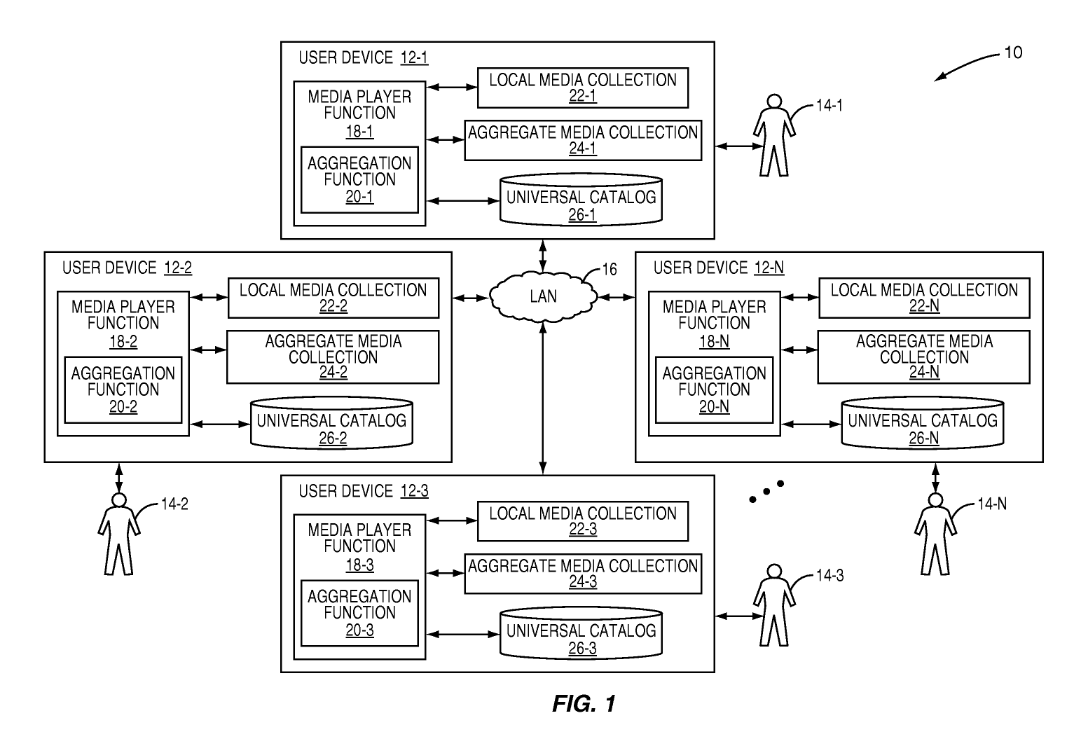

FIG. 1 illustrates an exemplary media sharing system 10 in which personalized metadata for media items is maintained according to one embodiment of the present invention. In general, the system 10 includes a number of user devices 12-1 through 12-N having associated users 14-1 through 14-N. In this embodiment, the user devices 12-1 through 12-N are connected via a Local Area Network (LAN) 16 and are part of the same subnetwork. However, the present invention is not limited thereto. The user devices 12-1 through 12-N may alternatively be connected via a Wide Area Network (WAN), a global network such as the Internet, or the like. As yet another alternative, some of the user devices 12-1 through 12-N may be connected via a LAN while others are connected via a WAN or global network.

Each of the user devices 12-1 through 12-N may be, for example, a personal computer, a mobile smart phone, a set-top box, a portable media player, or the like. Looking at the user device 12-1, the user device 12-1 includes a media player function 18-1 which may be implemented in software, hardware, or a combination thereof. In addition to providing media playback capabilities, the media player function 18-1 includes an aggregation function 20-1. In an alternative embodiment, the aggregation function 20-1 may be implemented as a separate function. For example, if the media player function 18-1 is a software media player application, the aggregation function 20-1 may be implemented as a plug-in. In general, the aggregation function 20-1 operates to generate an aggregate media collection 24-1 for the user 14-1 including media items in a local media collection 22-1 of the user 14-1 and media items from one or more remote shared media collections of one or more of the other users 14-2 through 14-N.

In addition, as discussed below, the aggregation function 20-1 creates a universal catalog 26-1 including personalized metadata for the user 14-1 for each media item known to the user device 12-1. The media items known to the user device 12-1 are media items in the local media collection 22-1, media items from the one or more media collections shared with the user 14-1, and media items previously shared with the user 14-1. In addition, the media items known to the user device 12-1 may include additional media items identified by universal catalogs of other users 14-2 through 14-N shared with the user 14-1. The personalized metadata may include user-specific metadata such as, for example, user ratings and usage statistics such as play counts and last-played time stamps. The personalized metadata for a media item may also include a delete flag indicating that the user 14-1 does not want the media item to appear in the aggregate media collection 24-1 of the user 14-1. In addition or alternatively, the personalized metadata may include content metadata such as artist, album, genre, or the like where the user 14-1 is enabled to personalize the content metadata as desired. For example, the user 14-1 may alter the genre of a song to more specifically reflect the genre to which the user 14-1 believes that the song belongs. As discussed below, in addition to the personalized metadata for the user 14-1, the universal catalog 26-1 may include additional personalized metadata instances for media items for other users from the users 14-2 through 14-N.

Like the user device 12-1, the other user devices 12-2 through 12-N include media player functions 18-2 through 18-N having corresponding aggregation functions 20-2 through 20-N. In addition, the other user devices 12-2 through 12-N include local media collections 22-2 through 22-N, aggregate media collections 24-2 through 24-N, and universal catalogs 26-2 through 26-N of the users 14-2 through 14-N, respectively.

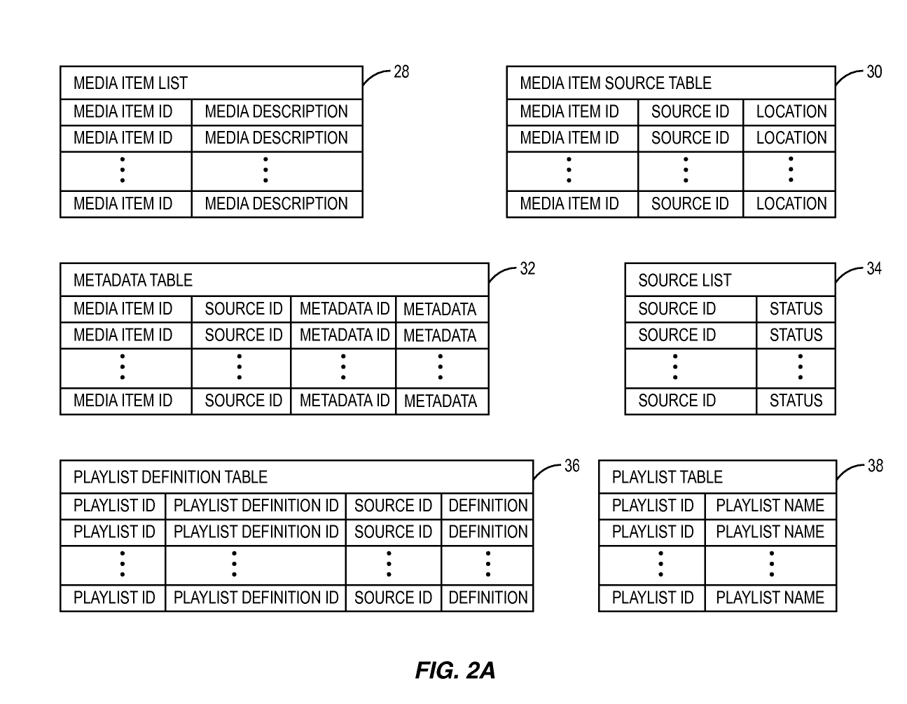

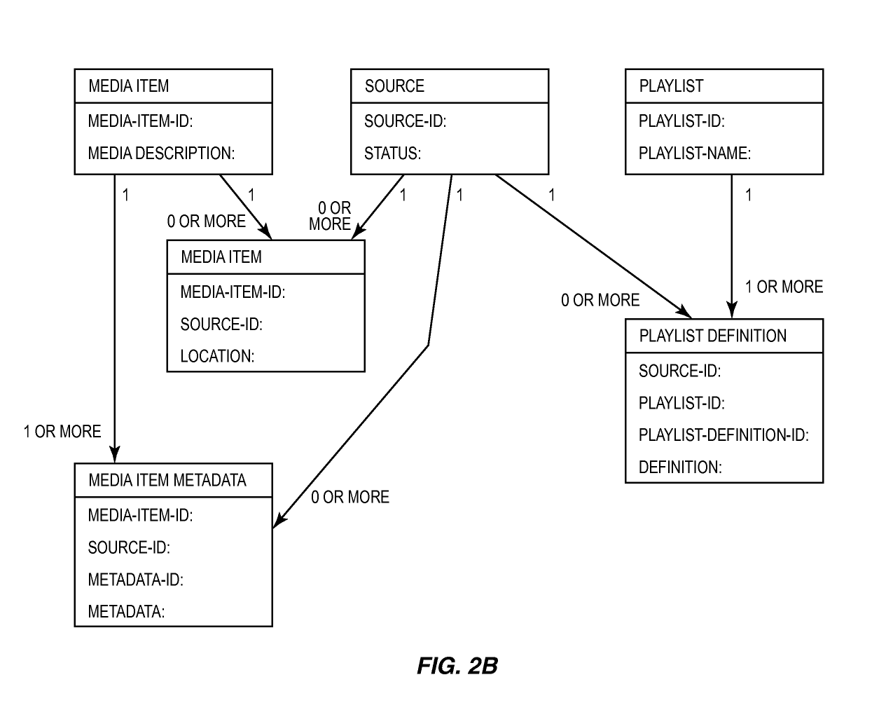

FIGS. 2A and 2B illustrate an exemplary embodiment of the universal catalog 26-1 of the user 14-1 according to one embodiment of the present invention. This discussion is equally applicable to the universal catalogs 26-2 through 26-N of the other users 14-2 through 14-N. Referring to FIG. 2A, in general, the universal catalog 26-1 includes media item list 28 including a media item entry for each media item known to the user device 12-1. The media items in the universal catalog 26-1 includes media items from the local media collection 22-1 of the user 14-1 as well as other media items that are or have been shared with the user 14-1. Still further, the media items in the universal catalog 26-1 may include media items that have not yet been shared with the user 14-1 from other universal catalogs shared with the user device 14-1. In this example, each media item entry in the media item list 28 includes a media item identifier (ID) of the corresponding media item. The media item IDs may be, for example, Globally Unique Identifiers (GUIDs) of the media items. However, the present invention is not limited thereto. Any type of information capable of uniquely identifying a media item may be used. In addition, each media item entry may include a description of the corresponding media item. For example, for a song, the description may be a title of the song.

In addition to the media item list 28, the universal catalog 26-1 of the user 14-1 includes a media item source table 30 that identifies one or more sources for each of the media items in the media item list 28. For each media item, the media item source table 30 includes an entry for each known source of the media item. Thus, in this example, each entry in the media item source table 30 includes a media item ID of the corresponding media item, a source ID identifying a user and/or user device that is the source of the corresponding media item, and a location or reference to the corresponding media item such as, for example, a Uniform Resource Locator (URL) for the corresponding media item.

The universal catalog 26-1 also includes a metadata table 32. The metadata table 32 stores one or more metadata instances for each of the media items in the media item list 28. In this embodiment, for each media item in the media item list 28, the metadata table 32 stores a metadata instance for each known source of the media item. Each metadata instance for a media item is also referred to herein as personalized metadata for the corresponding user. As such, metadata instances wherein the source ID identifies the user 14-1 or the user device 12-1 as the source are referred to as personalized metadata of the user 14-1 and/or user device 12-1 for the corresponding media items.

More specifically, in this example, the metadata table 32 includes an entry for each unique media item ID and source ID combination. Each entry in the metadata table 32 stores metadata for the corresponding media item for the corresponding source (e.g., user or user device). The metadata includes personalized metadata and, optionally, fixed metadata. Alternatively, the fixed metadata may be maintained separately from the personalized metadata. The personalized metadata may include user-specific metadata such as, for example, user ratings and usage statistics such as play counts and last-played time stamps. In addition or alternatively, the personalized metadata may include content-specific metadata that may be modified by the corresponding user. Using a song as an exemplary media item, personalized metadata may include a user rating applied to the song, a last-played time stamp, or the like. Content-specific metadata for the song such as, for example, an artist of the song, a title of the song, an album on which the song was released, a date the song was released, a genre of the song, or the like may be fixed. Note that in an alternative embodiment, the user may be enabled to personalize at least some content-specific metadata.

The universal catalog 26-1 of the user 14-1 also includes a source list 34. The source list 34 is a list of source IDs of other users or user devices that are sharing media items or have shared media items with the user 14-1 in the past. In addition, the source list 34 may include source IDs of other users or user devices known as a result of aggregation of universal catalogs, as discussed below. For each source, the source list 34 may also indicate a status of the source such as online/offline.

The universal catalog 26-1 also includes a playlist definition table 36. Each entry in the playlist definition table 36 includes a playlist ID of a playlist formed based on the corresponding definition, a playlist definition ID uniquely identifying the playlist definition, a source ID identifying a source of the playlist definition, and the playlist definition. The playlist definition may be a list of one or more media items forming a static playlist or one or more criteria defining a dynamic or smart playlist. Lastly, the universal catalog 26-1 includes a playlist table 38 including an entry for each of a number of known playlists. Each entry in the playlist table 38 includes a playlist ID of the corresponding playlist and a playlist name. The media items in the playlist are defined by the corresponding playlist definition in the playlist definition table 36 as well as a select source ID. FIG. 2B graphically illustrates the relationships between the various elements of the universal catalog 26-1 of FIG. 2A.

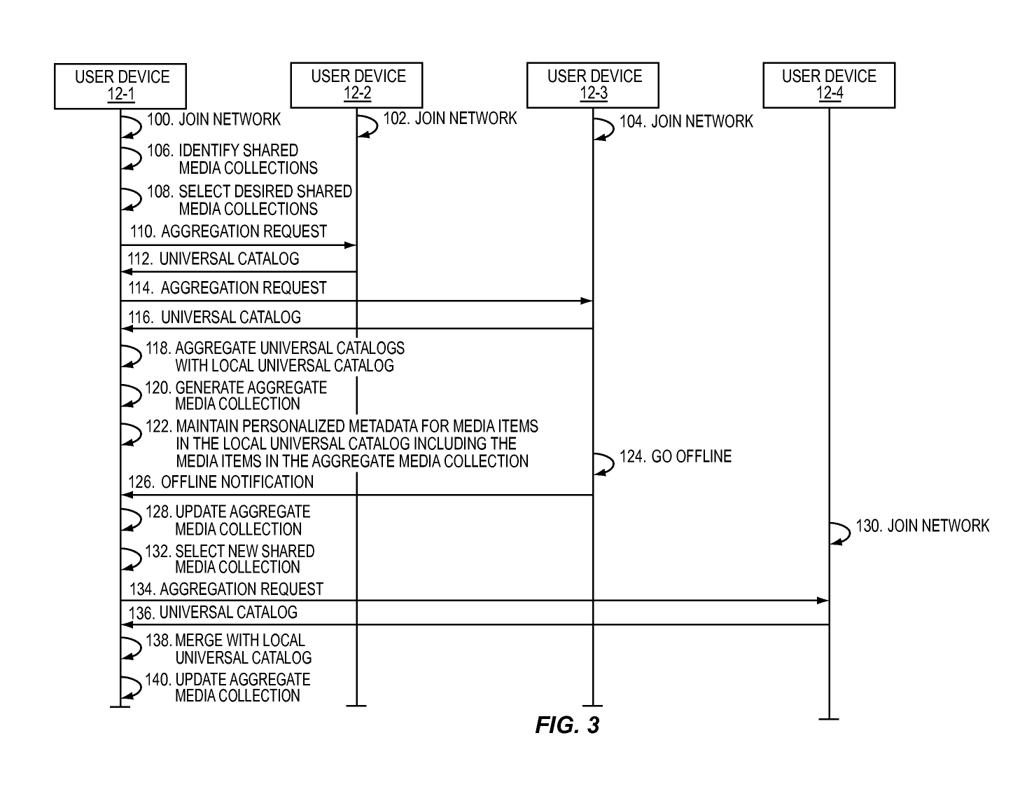

FIG. 3 illustrates the operation of the system 10 of FIG. 1 according to one embodiment of the present invention. First, the user devices 12-1, 12-2, and 12-3 join the LAN 16 by, for example, coming online (steps 100-104). Next, the aggregation function 20-1 of the user device 12-1 identifies media collections shared by the users 14-2 and 14-3 of the user devices 12-2 and 12-3 (step 106). For example, in a MAC OSX environment where the user devices 12-1, 12-2, and 12-3 are connected via the LAN 16, Bonjour may be used to identify the shared media collections of the users 14-2 and 14-3. In this embodiment, the aggregation function 20-1 presents a list of the shared media collections of the users 14-2 and 14-3 to the user 14-1 and then receives user input from the user 14-1 selecting one or more of the shared media collections for aggregation (step 108). In this example, the user 14-1 selects both of the shared media collections of the users 14-2 and 14-3 of the user devices 12-2 and 12-3.

The aggregation function 20-1 then issues an aggregation request to the user device 12-2 of the user 14-2 (step 110). In response, in this embodiment, the aggregation function 20-2 of the user device 12-2 returns the universal catalog 26-2 of the user 14-2 to the user device 12-1 of the user 14-1 (step 112). Likewise, the aggregation function 20-1 issues an aggregation request to the user device 12-3 of the user 14-3 (step 114). In response, the aggregation function 20-3 of the user device 12-3 returns the universal catalog 26-3 of the user 14-3 to the user device 12-1 of the user 14-1 (step 116).

Upon receiving the universal catalogs 26-2 and 26-3 of the users 14-2 and 14-3, the aggregation function 20-1 of the user device 12-1 aggregates or merges the universal catalogs 26-2 and 26-3 of the users 14-2 and 14-3 with the universal catalog 26-1 of the user 14-1, thereby updating the universal catalog 26-1 of the user 14-1 (step 118). The aggregation function 20-1 then processes the universal catalog 26-1 of the user 14-1 to generate the aggregate media collection 24-1 of the user 14-1 (step 120). More specifically, in one embodiment, the aggregation function 20-1 processes the universal catalog 26-1 of the user 14-1 to provide a list of unique media items available either from the local media collection of the user 14-1 or one of the shared media collections selected by the user 14-1 in step 108. In addition, for each unique media item, a secondary list of available sources for the unique media item may be generated. Together, the list of unique media items and the corresponding secondary lists of sources for the unique media items form the aggregate media collection 24-1 of the user 14-1. For more information, the interested reader is directed to commonly owned and assigned U.S. patent application Ser. No. 12/104,572, entitled METHOD AND SYSTEM FOR AGGREGATING MEDIA COLLECTIONS BETWEEN PARTICIPANTS OF A SHARING NETWORK, which was filed on Apr. 17, 2008 and is hereby incorporated by reference in its entirety.

In addition to including media items, the aggregate media collection 24-1 of the user 14-1 may include an aggregate list of playlists. More specifically, the local media collection 22-1 of the user 14-1 as well as the local media collections 22-2 and 22-3 of the users 14-2 and 14-3 may include static or dynamic playlists. As discussed above with respect to FIGS. 2A and 2B, these playlists may be included in the universal catalogs 26-1, 26-2, and 26-3 of the users 14-1, 14-2, and 14-3. As such, the aggregate media collection 26-1 of the user 14-1 may also include the playlists shared by the users 14-2 and 14-3. Further, if two or more playlists have the same title, the playlists may be aggregated or merged.

Once the aggregate media collection 24-1 is generated, the user 14-1 may utilize the aggregate media collection 24-1 in much the same manner as using the local media collection 22-1. For example, the user 14-1 may select media items from the aggregate media collection 24-1 for playback, generate playlists including media items from the aggregate media collection 24-1, generate smart or dynamic playlists that are populated from the aggregate media collection 24-1, or the like. In one embodiment, in order to provide playback of a media item that is from a shared media collection of another user, the media item is requested from the user device hosting the media item and streamed from that user device to the user device 12-1 of the user 14-1.

In addition, the media player function 18-1 and/or the aggregation function 20-1 maintains personalized metadata for the user 14-1 for media items in the aggregate media collection 24-1 (step 122). For example, the personalized metadata for the user 14-1 may include user-specific metadata such as, for example, user ratings and usage statistics such as play counts and last-played time stamps for the media items in the aggregate media collection 24-1. The personalized metadata may also include content-specific metadata such as genre, artist, title, and the like. For example, the user 14-1 may be enabled to personalize content-specific metadata such as a title of a song, an artist of a song, a genre of a song, or the like. In an alternative embodiment, some or all of the content-specific metadata may be fixed. For example, metadata such as the title and artist of a song may be fixed such that the user 14-1 is unable to personalize those metadata elements. Note that rather than maintaining personalized metadata for the user 14-1 only for media items in the local media collection 22-1 of the user 14-1, personalized metadata is maintained for the user 14-1 for all media items in the aggregate media collection 24-1.

In this example, the user device 12-3 goes offline (step 124). For example, the user 14-3 may disable sharing. In response, the user device 12-3 provides an offline notification to the user device 12-1 (step 126). Note that if the user device 12-3 goes offline due to a network connection failure, the user device 12-3 may be unable to provide the offline notification to the user device 12-1. In this case, the aggregation function 20-1 may detect that user device 12-3 has gone offline. For example, the user device 12-3 may be required to periodically send a “keep alive” message to the user device 12-1. If a “keep alive” message is not received for at least a defined threshold amount of time, then the aggregation function 20-1 of the user device 12-1 may determine that the user device 12-3 is offline. In response to the user device 12-3 having gone offline, the aggregation function 20-1 updates the aggregate media collection 24-1 accordingly (step 128).

In addition, in this example, around the same time that the user device 12-3 goes offline, the user device 12-4 joins the network (step 130). In one embodiment, the aggregation function 20-1 of the user device 12-1 then updates a list of available shared media collections to further include a shared media collection of the user device 12-4. In this example, the aggregation function 20-1 of the user device 12-1 then receives user input from the user 14-1 selecting the shared media collection of the user 14-4 for aggregation (step 132). In response, the aggregation function 20-1 of the user device 12-1 sends an aggregation request to the user device 12-4 (step 134). The aggregation function 20-4 of the user device 12-4 then returns the universal catalog 26-4 of the user 14-4 to the user device 12-1 (step 136). The aggregation function 20-1 then aggregates the universal catalog 26-4 of the user 14-4 with the universal catalog 26-1 of the user 14-1, thereby providing an updated universal catalog 26-1 for the user 14-1 (step 140). From this point, the process continues to provide aggregation of the shared media collection as well as the persistence of personalized metadata as discussed above.

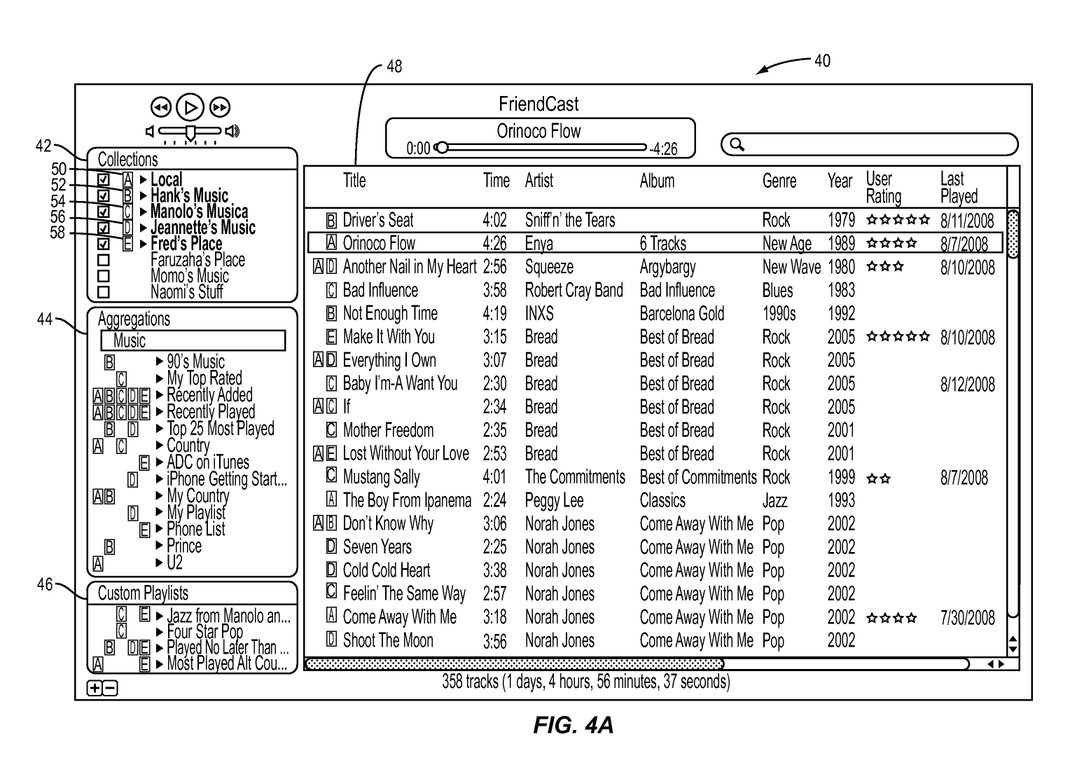

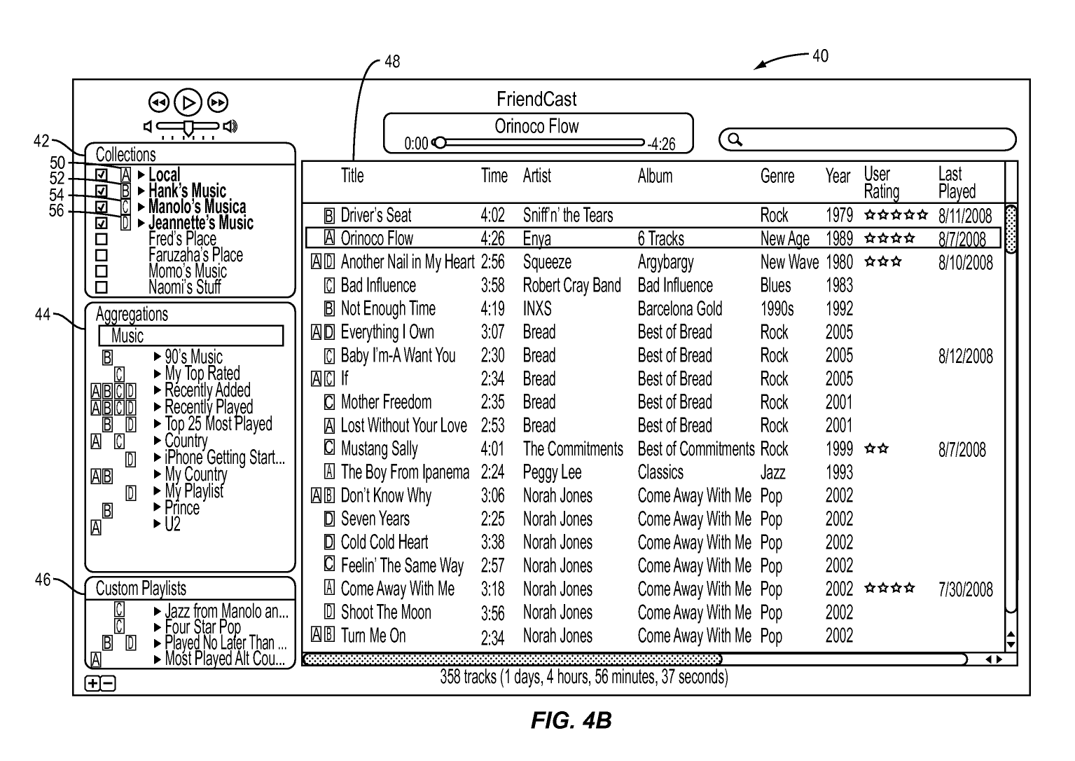

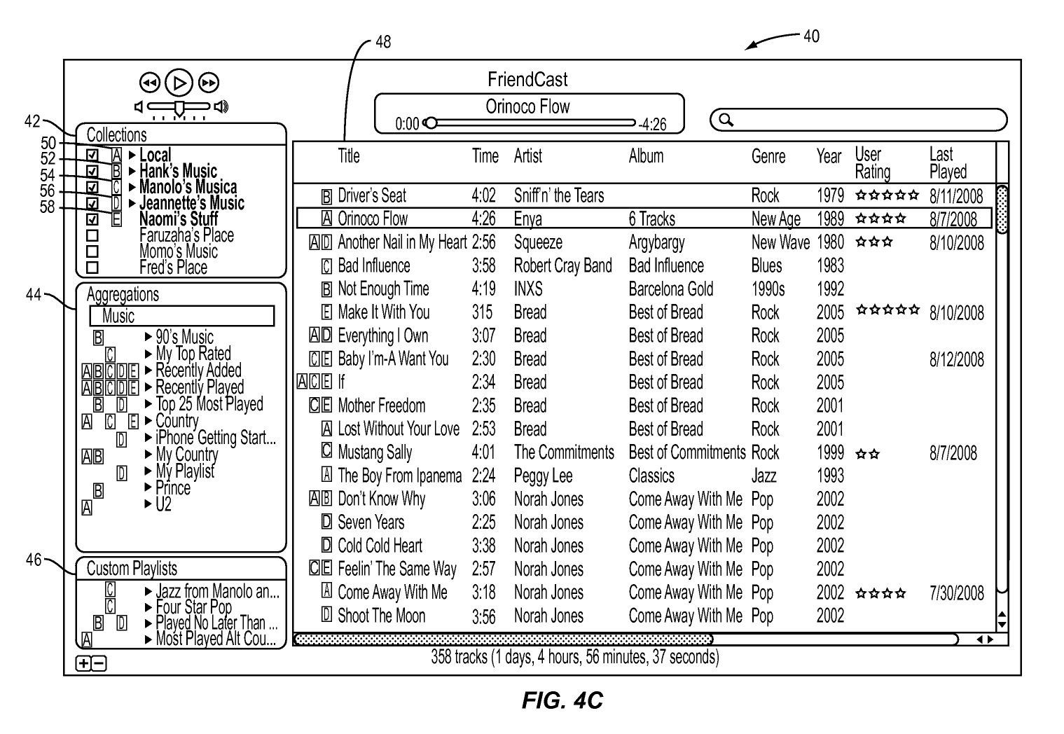

FIGS. 4A through 4C graphically illustrate the operation of the system 10 of FIG. 1 according to one embodiment of the present invention. FIG. 4A illustrates an exemplary Graphical User Interface (GUI) 40 of the media player function 18-1 of the user device 12-1. The GUI 40 includes a collection selection area 42, an aggregate media collection area 44, a custom playlists area 46, and a display area 48. The collection selection area 42 presents a list of media collections available for aggregation including the location media collection 22-1 of the user 14-1 and a number of shared media collections that are currently available to the user 14-1. In addition, the collection selection area 42 enables the user 14-1 to select one or more media collections for aggregation. In this example, the user 14-1 has selected his local media collection 22-1 and the shared media collections entitled “Hank's Music,” “Manolo's Musica,” “Jeannete's Music,” and “Fred's Place.” Note that in this example, the user 14-1 is limited to aggregating five (5) media collections. In this embodiment, once the desired shared media collections are selected, the universal catalogs are obtained from the corresponding user devices and aggregated to provide an updated universal catalog 26-1 for the user 14-1. The updated universal catalog 26-1 for the user 14-1 is then processed to generate the aggregate media collection 24-1 of the user 14-1.

The aggregate media collection area 44 enables the user 14-1 to navigate the aggregate media collection 24-1. In this example, the user 14-1 has selected “Music.” As a result, the entire aggregate media collection 24-1 of the user 14-1 is presented in the display area 48. Indicators 50, 52, 54, 56, and 58, which are associated with the selected media collections in the collection selection area 42, are utilized to indicate the source(s) of the media items in the aggregate media collection 24-1 presented in the display area 48. Thus, for example, the source of the song “Driver's Seat” is the shared media collection entitled “Hank's Music.” Likewise, the song “Another Nail in My Heart” has two sources: the local media collection 22-1 of the user 14-1 and the shared media collection entitled “Jeanette's Music.” The aggregate media collection area 44 also presents the aggregate playlists as well as sources for media items in the aggregate playlists in the aggregate media collection 24-1 of the user 14-1. The custom playlists area 46 presents a number of playlists created by the user 14-1 to include media items from the aggregate media collection 24-1 of the user 14-1. The custom playlists were created by the user 14-1 for the aggregate media collection 24-1 and were not imported from the local media collection 22-1 of the user 14-1.

In addition, the GUI 40 illustrates personalized metadata of the user 14-1 for the media items in the aggregate media collection 24-1 of the user 14-1. In this example, the personalized metadata of the user 14-1 includes user ratings and last-played time stamps. However, the present invention is not limited thereto. As discussed above, the personalized metadata of the user 14-1 is stored in the universal catalog 26-1 of the user 14-1. Note that while the user 14-1 is enabled to provide user ratings for all of the media items in the aggregate media collection 24-1, the user 14-1 is not required to assign user ratings to all of the media items in the aggregate media collection 24-1. For instance, in this example, the user 14-1 has applied user ratings to some, but not all, of the media items in the aggregate media collection 24-1. In addition, the last-played time stamps indicate the dates on which the corresponding media items were last played by the user 14-1. As such, if the user 14-1 has not yet played a media item, then there will not yet be a last-played time stamp for that media item. Further, the ratings, last played, and the other columns in the display area 48 may display the personalized metadata of the current user, the personalized metadata of one or more of the sharing users, or a combination thereof. For example, the user 14-1 may configure the GUI 40 such that his own personalized metadata is presented in the display area 48, the personalized metadata of one of the other users 14-2 through 14-N is presented in the display area 48, or both. As another example, the user 14-1 may configure the GUI 40 such that the personalized metadata for the user 14-1 and the other sharing users is combined and the combined personalized metadata is presented in the display area 48. Using ratings as an example, the ratings of the user 14-1 and the other sharing users may be averaged to provide average ratings for the media items.

FIG. 4B illustrates the GUI 40 after the shared media collection “Fred's Place” has gone offline. As a result, media items whose only source is “Fred's Place” are removed from the aggregate media collection 24-1 of the user 14-1. However, note that the corresponding entries in the universal catalog 26-1 of the user 14-1 are not removed. As such, the personalized metadata for the media items in the shared media collection “Fred's Place” is not lost but is instead persisted in the universal catalog 26-1 of the user 14-1. For instance, in this example, the song “Make It With You” is removed from the aggregate media collection 24-1 because “Fred's Place” was the only source for this song. However, the user rating and last-played time stamp for “Make It With You” are persisted in the universal catalog 26-1 of the user 14-1.

FIG. 4C illustrates the GUI 40 after the shared media collection “Fred's Place” has gone offline and the user 14-1 has selected the shared media collection “Naomi's Stuff” for aggregation. As a result, the corresponding universal catalog is obtained and aggregated with the universal catalog 26-1 of the user 14-1. The aggregation function 20-1 then updates the aggregate media collection 24-1 of the user 14-1 to include media items from the shared media collection “Naomi's Stuff.” Notably, in this example, the shared media collection “Naomi's Stuff” includes the song “Make It With You.” As such, the song “Make It With You” is again in the aggregate media collection 24-1 of the user 14-1. Further, since the user rating and last-played time stamp for “Make It With You” are persisted in the universal catalog 26-1 of the user 14-1, the user rating and last-played time stamp are available and therefore presented in the display area 48.

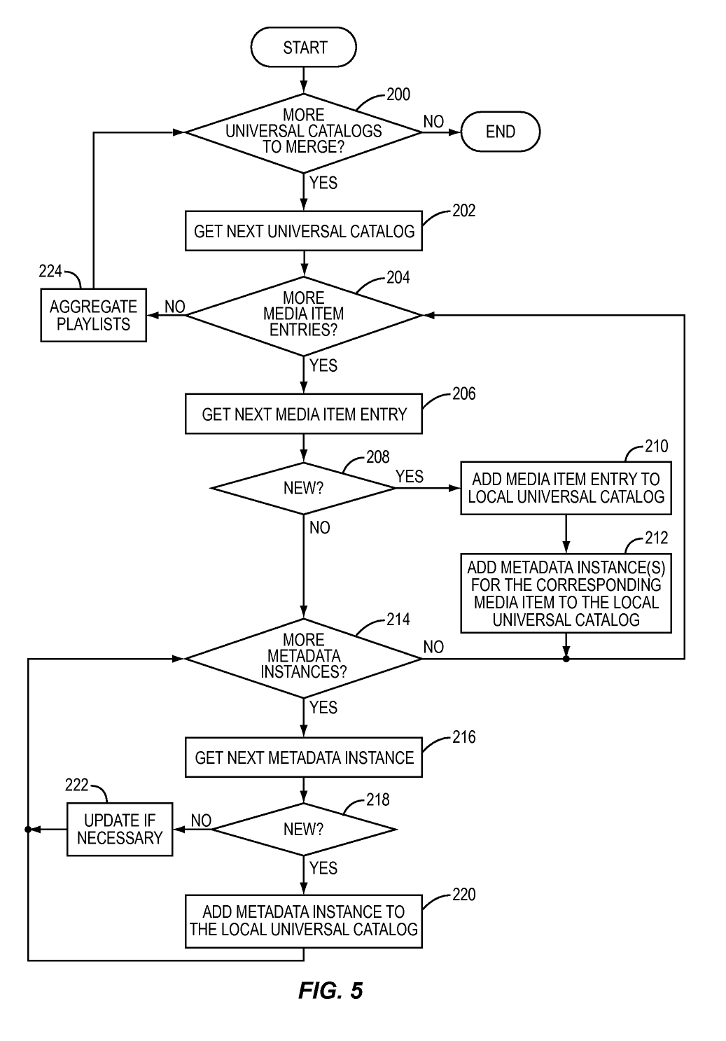

FIG. 5 is a flow chart illustrating a more detailed process for aggregating universal catalogs according to one embodiment of the present invention. Using the aggregation function 20-1 of the user device 12-1 as an example, the aggregation function 20-1 first determines whether there are universal catalogs to be aggregated (step 200). If not, the process ends. If so, the aggregation function 20-1 obtains the next universal catalog to aggregate with the universal catalog 26-1 of the user 14-1 (step 202). Note that the universal catalog 26-1 may be initialized with the local media collection 22-1 of the user 14-1. Then, the aggregation function 20-1 determines whether the universal catalog to aggregate with the universal catalog 26-1 of the user 14-1 includes more media item entries (step 204). More specifically, using the embodiment of a universal catalog illustrated in FIG. 2, the aggregation function 20-1 determines whether there are more entries in the media item list of the universal catalog to aggregate with the universal catalog 26-1 of the user 14-1.

If there are more media item entries to process, the aggregation function 20-1 obtains the next media item entry in the universal catalog to aggregate with the universal catalog 26-1 of the user 14-1 (step 206) and determines whether the corresponding media item is new to the universal catalog 26-1 (step 208). If so, the aggregation function 20-1 adds a media item entry for the media item to the universal catalog 26-1 and may also create a personalized metadata instance for the media item for the user 14-1 (step 210). In addition, the aggregation function 20-1 adds all metadata instances for the media item from the universal catalog being aggregated to the universal catalog 26-1 (step 212). At this point, the process returns to step 204 and is repeated until there are no more media item entries to be processed.

Returning to step 208, if the media item corresponding to the media item entry is not new to the universal catalog 26-1, then the aggregation function 20-1 determines whether there are more metadata instances for the media item in the universal catalog being aggregated to be processed (step 214). If not, the process returns to step 204. If so, the aggregation function 20-1 gets the next metadata instance for the media item from the universal catalog being aggregated (step 216) and determines whether the metadata instance is new to the universal catalog 26-1 (step 218). If so, the aggregation function adds the metadata instance to the universal catalog 26-1 (step 220). Note that the corresponding sources may also be added to the source list in the universal catalog 26-1 at this time. If the metadata instance is not new, the aggregation function 20-1 updates the corresponding metadata instance in the universal catalog 26-1 if necessary (step 222). At this point, whether proceeding from step 220 or step 222, the process returns to step 214 and is repeated.

Returning to step 204, if there are no more media item entries, the aggregation function 20-1 may then aggregate the playlists in the universal catalog being processed with the playlists in the universal catalog 26-1 (step 224). At this point, the process returns to step 200 and is repeated.

While the discussion above focuses on an embodiment of the universal catalogs 26-1 through 26-N of the users 14-1 through 14-N where the universal catalogs 26-1 through 26-N include multiple metadata instances, the present invention is not limited thereto. In an alternative embodiment, using the universal catalog 26-1 of the user 14-1 as an example, the universal catalog 26-1 includes only one metadata instance per media item. More specifically, for each media item in the universal catalog 26-1, the universal catalog 26-1 includes only one metadata instance for that media item, which is a personalized metadata instance for that media item for the user 14-1.

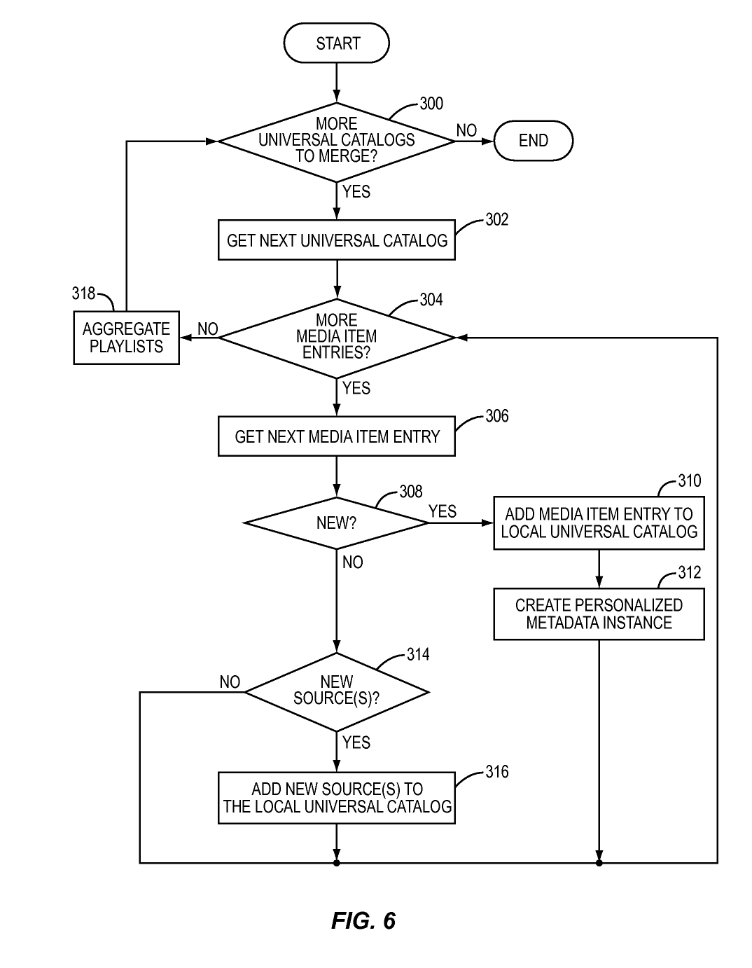

FIG. 6 is a flow chart illustrating an alternative universal catalog aggregation process for providing a universal catalog including a personalized metadata instance for each media item for the corresponding user according to another embodiment of the present invention. Again using the aggregation function 20-1 of the user device 12-1 as an example, the aggregation function 20-1 first determines whether there are universal catalogs to be aggregated (step 300). If not, the process ends. If so, the aggregation function 20-1 obtains the next universal catalog to aggregate with the universal catalog 26-1 of the user 14-1 (step 302). Note that the universal catalog 26-1 may be initialized with the local media collection 22-1 of the user 14-1. Then, the aggregation function 20-1 determines whether the universal catalog to aggregate with the universal catalog 26-1 of the user 14-1 includes more media item entries (step 304). More specifically, using the embodiment of a universal catalog illustrated in FIG. 2, the aggregation function 20-1 determines whether there are more entries in the media item list of the universal catalog to aggregate with the universal catalog 26-1 of the user 14-1.

If there are more media item entries to process, the aggregation function 20-1 obtains the next media item entry in the universal catalog to aggregate with the universal catalog 26-1 of the user 14-1 (step 306) and determines whether the corresponding media item is new to the universal catalog 26-1 (step 308). If so, the aggregation function 20-1 adds a media item entry for the media item to the universal catalog 26-1 (step 310). In addition, the aggregation function 20-1 creates a personalized metadata instance for the media item for the user 14-1 in the universal catalog 26-1 (step 312). The personalized metadata instance may be initialized with content-specific metadata from, for example, the universal catalog being processed. The personalized metadata instance may thereafter be maintained and updated during operation of the media player function 18-1. For example, as the user 14-1 plays the media item, a last-played time stamp may be updated. Similarly, the user 14-1 may thereafter apply a user rating to the media item, where the user rating is then stored in the personalized metadata instance for the media item in the universal catalog 26-1. At this point, the process returns to step 304 and is repeated until there are no more media item entries to be processed.

Returning to step 308, if the media item corresponding to the media item entry is not new to the universal catalog 26-1, then the aggregation function 20-1 determines whether there are any new sources for the media item identified in the universal catalog being processed (step 314). If not, the process returns to step 304 and is repeated. If so, the aggregation function 20-1 adds the new source(s) to the universal catalog 26-1 (step 316), and then the process returns to step 304 and is repeated. Returning to step 304, if there are no more media item entries, the aggregation function 20-1 may then aggregate the playlists in the universal catalog being processed with the playlists in the universal catalog 26-1 (step 318). At this point, the process returns to step 300 and is repeated.

FIG. 7 is a flow chart illustrating an alternative universal catalog aggregation process for providing a universal catalog including a personalized metadata instance for each media item for the corresponding user according to yet another embodiment of the present invention. Again using the aggregation function 20-1 of the user device 12-1 as an example, in this embodiment, the user device 12-1 does not obtain the universal catalogs when aggregating shared media collections. Rather, shared media collection information identifying media items and, optionally, playlists in the shared media collections are obtained from corresponding user devices. After receiving the shared media collection information for the shared media collections to be aggregated, the aggregation function 20-1 first determines whether there are more shared media collections to aggregate (step 400). If not, the process ends. If so, the aggregation function 20-1 obtains the shared media collection information for the next shared media collection to aggregate with the universal catalog 26-1 of the user 14-1 (step 402). Note that the universal catalog 26-1 may be initialized with the local media collection 22-1 of the user 14-1. Then, the aggregation function 20-1 determines whether the shared media collection includes more media item entries to process (step 404). More specifically, in this embodiment, the shared media collection information for the shared media collection includes a media item list including an entry for each media item in the shared media collection. The shared media collection may be the local media collection of the corresponding user or the aggregate media collection of the corresponding user. Thus, the aggregation function 20-1 determines whether the shared media collection includes more media entries to process by determining whether the media item list includes more media item entries to aggregate with the universal catalog 26-1 of the user 14-1.

If there are more media item entries to process, the aggregation function 20-1 obtains the next media item entry in the shared media collection information (step 406) and determines whether the corresponding media item is new to the universal catalog 26-1 (step 408). If so, the aggregation function 20-1 adds a media item entry for the media item to the universal catalog 26-1 (step 410). In addition, the aggregation function 20-1 creates a personalized metadata instance for the media item for the user 14-1 in the universal catalog 26-1 (step 412). The personalized metadata instance may be initialized with content-specific metadata, which may, for example, be provided as part of the shared media collection information. The personalized metadata instance may thereafter be maintained and updated during operation of the media player function 18-1. For example, as the user 14-1 plays the media item, a last-played time stamp may be updated. Similarly, the user 14-1 may thereafter apply a user rating to the media item, where the user rating is then stored in the personalized metadata instance for the media item in the universal catalog 26-1. At this point, the process returns to step 404 and is repeated until there are no more media item entries to be processed.

Returning to step 408, if the media item corresponding to the media item entry is not new to the universal catalog 26-1, then the aggregation function 20-1 determines whether the user, or user device, corresponding to the shared media collection is a new source for the media item (step 414). If not, the process returns to step 404 and is repeated. If so, the aggregation function 20-1 adds the user, or user device, corresponding to the shared media collection as a new source for the media item in the universal catalog 26-1 (step 416), and then the process returns to step 404 and is repeated. Returning to step 404, once there are no more media item entries to process, the aggregation function 20-1 may then aggregate the playlists in the shared media collection being processed with the playlists in the universal catalog 26-1 (step 418). At this point, the process returns to step 400 and is repeated.

Note that while the discussion above focuses on the embodiment where the universal catalog 26-1 of the user 14-1 is processed to provide the aggregate media collection 24-1 of the user 14-1 including media items from the local media collection 22-1 of the user 14-1 as well as media items from one or more shared media collections, the present invention is not limited thereto. The user 14-1 may alternatively view the universal catalog 26-1, filter or search the universal catalog 26-1, or the like. For example, the user 14-1 may be enabled to view the entire universal catalog 26-1, where the universal catalog 26-1 may be presented in any desired format. As another example, the user 14-1 may be enabled to filter or search the universal catalog 26-1 based on one or more defined criteria. The one or more criteria may be a list of one or more users/sources, a last-played time range, a threshold user rating, availability, or the like. Media items from the universal catalog 26-1 that satisfy the one or more criteria may then be viewed or returned to the user 14-1.

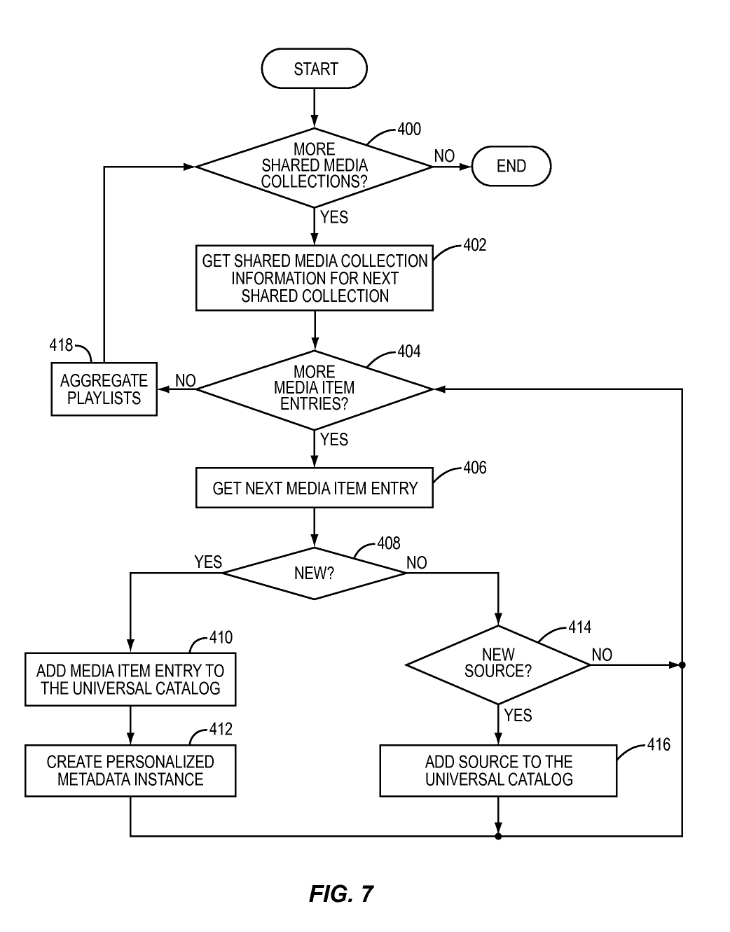

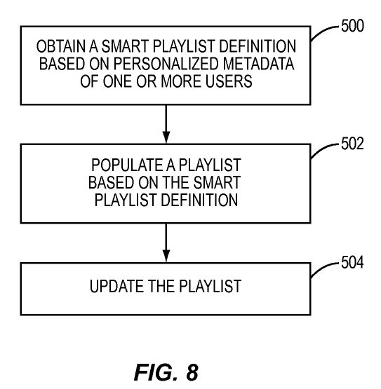

FIG. 8 illustrates a process for defining and populating a smart playlist according to one embodiment of the present invention. Again, using the user device 12-1 of the user 14-1 as an example, the user device 12-1 first obtains a playlist definition for a smart playlist that is defined based on personalized metadata of one or more users (step 500). The playlist definition for the smart playlist generally includes one or more media criteria. For example, if the smart playlist is a song playlist, the one or more media criteria in the definition for the smart playlist may be one or more music genres, one or more artists, one or more albums, one or more time periods, or the like.

In addition, the definition for the smart playlist may include one or more user criteria. The user criteria may include, for example, a threshold user rating value, a range of user rating values, a time period in which desired media items for the smart playlist were last played, a threshold play count value, a range of play count values, a threshold score or range of scores where media items are scored based on user preferences of the user 14-1, or the like. In one embodiment, the definition for the smart playlist may also include information associated with the user criteria identifying a user whose personalized metadata is to be used with respect to the user criteria when populating the smart playlist. More specifically, in one embodiment, the playlist definition may state that the personalized metadata for a defined user is to be used when populating the smart playlist. The defined user may be the local user which in this example is the user 14-1, the user creating the playlist definition, or the source of each individual media item. Note that if the personalized metadata for the source is to be used, then the personalized metadata for one of the sources may be used or the personalized metadata for all of the sources may be combined such that the combined personalized metadata is used when populating the smart playlist.

In another embodiment, the playlist definition may provide a list of users whose personalized metadata is to be used with respect to the user criteria when populating the smart playlist. Priorities or an order of preference may be assigned to the users in the list. For example, the order of the users in the list may define the order of preference of the users. Thus, for example, for each media item in a pool of media items from which the smart playlist is to be populated, the personalized metadata for the first user in the list is used if available. If personalized metadata for the first user in the list is not available, then personalized metadata for the second user in the list is used if available, and so on.

Lastly, the playlist definition for the smart playlist may include playlist control criteria. The playlist control criteria may include, for example, a criterion indicating that only available or online media items are to be included in the smart playlist; a criterion defining a maximum number of media items to be included in the smart playlist; one or more criteria defining or selecting a pool of media items from which the smart playlist is to be populated; or the like.

In one embodiment, the playlist definition is created by the user 14-1 and stored in the universal catalog 26-1 of the user 14-1. In another embodiment, the playlist definition is created by another user and shared with the user 14-1 via, for example, the universal catalog of that user or another user. Note that when shared by another user, the shared playlist definition may not initially include user criteria and/or playlist control criteria. The user criteria and/or playlist control criteria may be added by the user 14-1 in order to personalize the smart playlist. Alternatively, the shared playlist definition for the smart playlist may include user criteria and/or playlist control criteria, which may be further personalized or configured by the user 14-1.

Next, the smart playlist is populated based on the playlist definition (step 502). In one embodiment, the smart playlist is populated from the aggregate media collection 24-1 of the user 14-1. In another embodiment, the smart playlist is populated from the universal catalog 26-1 of the user 14-1. In yet another embodiment, the smart playlist is populated from a group of media items selected by the user 14-1 or creator of the smart playlist definition. The group of media items selected by the user 14-1 or the creator of the smart playlist definition may be, for example, the local media collection 22-1 of the user 14-1, a selected subset of the local media collection 22-1, the aggregate media collection 24-1 of the user 14-1, a selected subset of the aggregate media collection 24-1 of the user 14-1, the universal catalog 26-1 of the user 14-1, a selected subset of the media items in the universal catalog 26-1 of the user 14-1, or the like.

Using the aggregate media collection 24-1 as an example, in one embodiment, the media player function 18-1 or the aggregation function 20-1 searches the aggregate media collection 24-1 for media items satisfying the one or more media criteria. The identified media items may then be pruned or filtered based on the one or more user criteria to provide a filtered list of media items. The filtered list of media items may then be further pruned or filtered based on the one or more playlist control criteria to provide a list of media items forming the smart playlist.

Once the smart playlist is populated, the smart playlist may subsequently be updated (step 504). More specifically, in one embodiment, the smart playlist is updated in response to one or more triggering events. The one or more triggering events may be, for example, a change to the playlist definition for the smart playlist, adding new media item(s) to the aggregate media collection 24-1 of the user 14-1, a change to the universal catalog 26-1 of the user 14-1 such as adding new media item(s) or adding or updating personalized metadata instance(s) in the universal catalog 26-1, a change in the status of a shared media collection source, or the like.

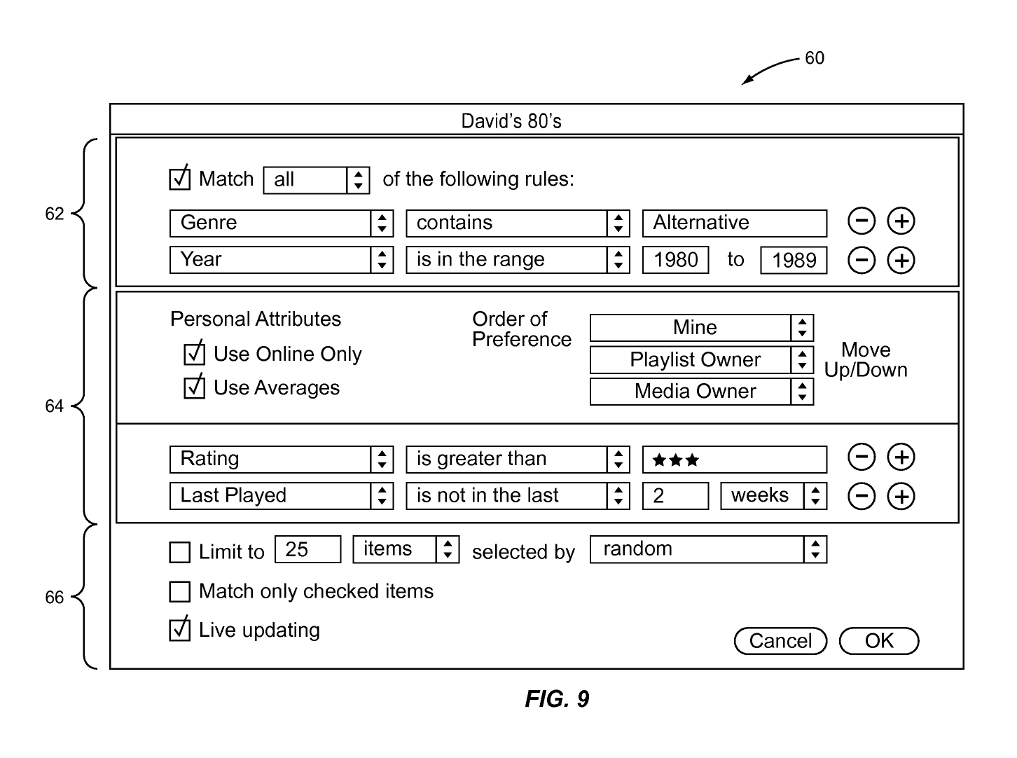

FIG. 9 illustrates an exemplary GUI 60 for defining or configuring a playlist definition for a smart playlist according to one embodiment of the present invention. The GUI 60 enables a user to define and/or personalize a smart playlist definition according to an exemplary embodiment of the present invention. In general, the GUI 60 includes a media criteria definition area 62, a user criteria definition area 64, and a playlist control criteria definition area 66. The media criteria definition area 62 enables the user to define one or more media criteria for the smart playlist definition. In this example, the one or more media criteria are a defined genre and a defined time period, which are the Alternative music genre and the 1980s, respectively. In addition, the one or more media criteria include a criterion that all of the shown media criteria must match before a media item is included in the smart playlist. Alternatively, the user may choose to define the playlist such that any one of the shown media criteria must match before a media item is included in the smart playlist.

The user criteria definition area 64 enables the user to personalize the smart playlist definition. The user criteria definition area 64 enables the user to define or configure a number of user criteria, which in this example are a user rating criteria and a last played criteria. More specifically, in this example, the user rating criteria indicates that media items in the smart playlist must have a user rating greater than three (3) out of five (5) stars, and the last played criteria indicates that media items in the smart playlist must have not been played within the last two (2) weeks. In addition, the user criteria definition area 64 enables the user to specify an order of preference for users whose personalized metadata is to be used with respect to the user rating criteria and last played criteria when populating the smart playlist. In this example, for each media item, the users own personalized metadata, if available, is to be compared to the user criteria to determine whether to include the media item in the smart playlist. If personalized metadata for the user is not available, then personalized metadata for the owner or creator of the smart playlist definition, if available, is to be compared to the user criteria to determine whether to include the media item in the smart playlist. Note that in some instances, the user and the creator of the smart playlist definition may be the same user. If personalized metadata is not available for either the user or the owner of the playlist definition, then personalized metadata for the media item owner or source is to be compared to the user criteria to determine whether to include the media item in the smart playlist. Note that if the media item has multiple sources, then, in this example, the personalized metadata for the multiple sources is to be combined or averaged. For example, the user ratings of the multiple sources may be averaged to provide a combined user rating for the media item. Alternatively, the personalized metadata for one of the sources for the media may be selected and used. Note that in this example the user criteria also include a criterion indicating whether the user desires to use the personal attributes of only those other users that are currently online.

The playlist control criteria definition area 66 enables the user to define one or more playlist control criteria. In this example, the playlist control criteria include criteria defining a maximum number of media items to be included in the smart playlist as well as a scheme to be used to limit the maximum number of media items to the desired number. The scheme may be selecting the defined maximum number of media items from a list of media items satisfying the other criteria of the smart playlist definition at random, based on scores assigned to the media items in the list based on user preferences of the user, or the like. Note that scores may be assigned to media items based on user preferences of the user such as, for example, weights assigned to a number of genres, weights assigned to a number of time periods, or the like. For an exemplary scoring process, the interested reader is directed to U.S. Patent Publication No. 2008/0016205 A1, entitled P2P NETWORK FOR PROVIDING REAL TIME MEDIA RECOMMENDATIONS, which was filed on Jul. 11, 2006 and is hereby incorporated herein by reference for its teachings on scoring media items. Note that in this example, the user has not chosen to limit the number of media items in the smart playlist to a maximum number.

In addition, the playlist control criteria may include a criterion that indicates that only checked or otherwise selected media items from the aggregate media collection of the user or the universal catalog of the user are to be used when populating the smart playlist. In this manner, the user may select a group of media items from which the smart playlist is to be populated. In a similar manner, the playlist control criteria may additionally or alternatively enable the user to select which collections to use when populating the smart playlist. The user may choose to populate the smart playlist from any number of the following: his local media collection, his aggregate media collection, the media items listed in his universal catalog, or one or more shared media collections. However, in an alternative embodiment, the collection from which the smart playlist is populated may be pre-configured. For example, the smart playlist may always be populated from the aggregate media collection of the user. As another example, the smart playlist may always be populated from the universal catalog of the user.

The playlist control criteria may also allow the user to enable or disable live updating. If live updating is enabled, the smart playlist is automatically updated in response to one or more defined triggering events. The one or more triggering events may be, for example, a change to the playlist definition for the smart playlist, adding new media item(s) to the aggregate media collection of the user, a change to the universal catalog of the user such as adding new media item(s) or adding or updating personalized metadata instance(s) in the universal catalog, a change in the status of a shared media collection source, or the like. If live updating is disabled, the smart playlist is initially populated. Thereafter, the user may manually choose to update the smart playlist if desired.

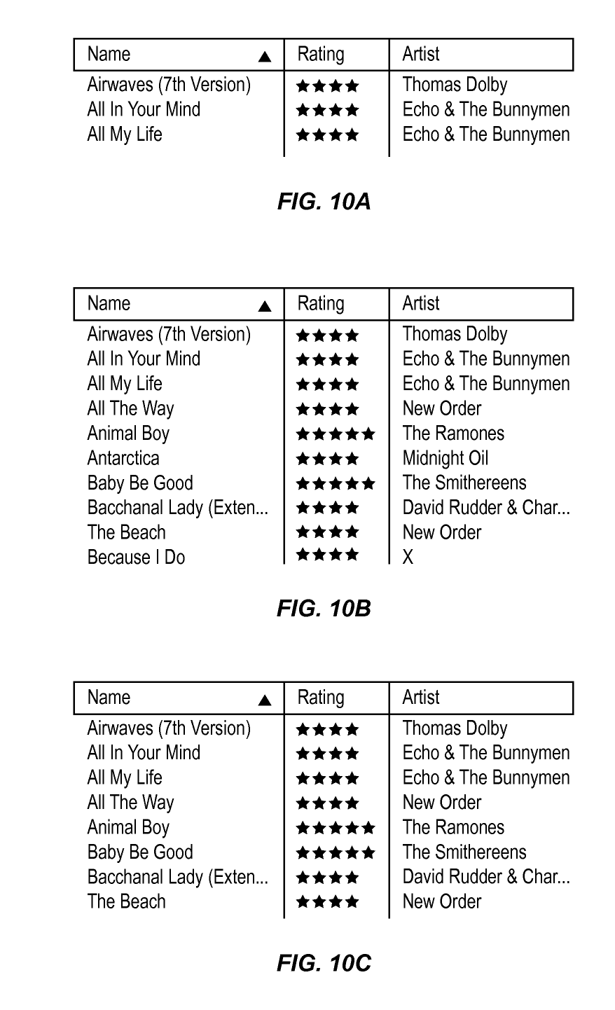

FIGS. 10A through 10C illustrate an exemplary use case according to one embodiment of the present invention. FIG. 10A illustrates a smart playlist populated using the smart playlist definition of FIG. 9 according to one embodiment of the present invention. FIG. 10B illustrates the same playlist after it has been automatically updated in response to a new shared media collection coming online and, optionally, being selected for aggregation. In this example, the user then lowers his personal user ratings for “Antarctica” and “Because I Do” each to a value of two (2) out of five (5) stars. As a result, as shown in FIG. 10C, the smart playlist is automatically updated to remove those two media items from the smart playlist since one of the user criteria is that the user ratings of the media items in the smart playlist be greater than three (3) out of five (5) stars.

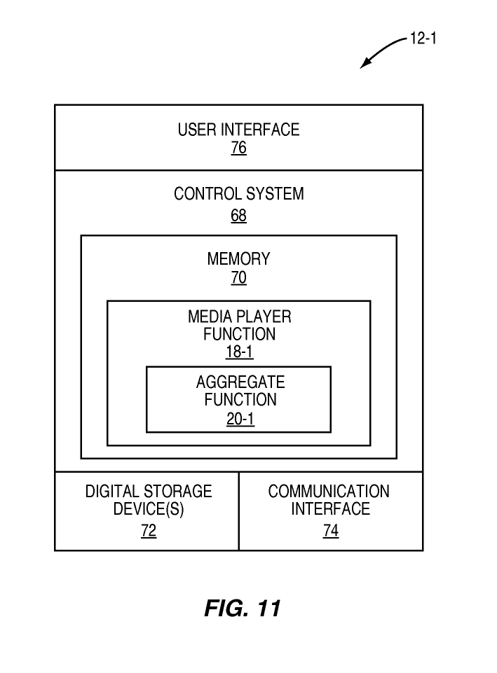

FIG. 11 is a block diagram of the user device 12-1 of FIG. 1 according to one embodiment of the present invention. This discussion is equally applicable to the other user devices 12-2 through 12-N. In general, the user device 12-1 includes a control system 68 having associated memory 70. In this example, the media player function 18-1 including the aggregation function 20-1 is implemented in software and stored in the memory 70. However, the present invention is not limited thereto. The media player function 18-1 including the aggregation function 20-1 may be implemented in software, hardware, or a combination thereof. The user device 12-1 also includes one or more digital storage devices 72 such as, for example, one or more hard disk drives or the like. In one embodiment, the local media collection 22-1, the aggregate media collection 24-1, and the universal catalog 26-1 are stored in the one or more digital storage devices 72. However, the present invention is not limited thereto. The user device 12-1 also includes a communication interface 74 communicatively coupling the user device 12-1 to the LAN 16 (FIG. 1). The communication interface 74 may be a wired or wireless connection. For example, the communication interface 74 may be an Ethernet connection, an IEEE 802.11x connection, or the like. The user device 12-1 also includes a user interface 76, which may include components such as, but not limited to, one or more user input devices, a display, a speaker, or the like.

The present invention provides substantial opportunity for variation without departing from the spirit or scope of the present invention. For example, while the system 10 of FIG. 1 is illustrated and described as a true Peer-to-Peer (P2P) system, the present invention is not limited thereto. The system 10 may alternatively be implemented as a hybrid P2P system including a central server operating to facilitate sharing of universal catalogs and media items according to the present invention.

Those skilled in the art will recognize improvements and modifications to the preferred embodiments of the present invention. All such improvements and modifications are considered within the scope of the concepts disclosed herein and the claims that follow.

What is claimed is:

1. A method of operation of a user device of a user comprising:
obtaining personalized metadata for each media item of at least a subset of a plurality of media items accessible to the user device via a media sharing system comprising one or more user devices of one or more sharing users hosting the plurality of media items and the user device of the user;
obtaining a smart playlist definition, the smart playlist definition comprising one or more user criteria; and
populating a smart playlist based on a comparison of the one or more user criteria of the smart playlist definition and the personalized metadata for the at least a subset of the plurality of media items.

2. The method of claim 1 wherein for each media item of the at least a subset of the plurality of media items, the personalized metadata for the media item comprises a personalized metadata instance for the media item for the user of the user device.

3. The method of claim 1 wherein for each media item of the at least a subset of the plurality of media items, the personalized metadata for the media item comprises a personalized metadata instance for the media item for at least one user other than the user of the user device.

4. The method of claim 1 wherein for each media item of the at least a subset of the plurality of media items, the personalized metadata for the media item comprises a personalized metadata instance for the media item for at least one of a group consisting of: the user of the user device and at least one user other than the user of the user device.

5. The method of claim 4 wherein the personalized metadata for at least one media item of the at least a subset of the plurality of media items comprises a personalized metadata instance for the user of the user device and a personalized metadata instance for at least one user other than the user of the user device.

6. The method of claim 5 wherein the smart playlist definition further comprises information defining an order of preference for personalized metadata instances of a plurality of users including the user of the user device and the at least one user other than the user of the user device.

7. The method of claim 6 wherein populating the smart playlist comprises, for each media item in a pool of media items including the plurality of media items:
if the media item has personalized metadata associated therewith, identifying a desired personalized metadata instance for the media item according to the order of preference for the personalized metadata instances for the plurality of users including the user of the user device and the at least one user other than the user of the user device;
making a determination as to whether to include the media item in the smart playlist based on a comparison of the desired personalized metadata instance and the one or more user criteria; and
including the media item in the smart playlist if the determination is made to include the media item in the smart playlist.

8. The method of claim 6 wherein populating the smart playlist comprises, for each media item in a pool of media items including the plurality of media items:
if the media item has personalized metadata associated therewith, identifying at least one desired personalized metadata instance for the media item according to the order of preference for the personalized metadata instances for the plurality of users including the user of the user device and the at least one user other than the user of the user device;
if there is only one desired personalized metadata instance:
making a determination as to whether to include the media item in the smart playlist based on a comparison of the desired personalized metadata instance and the one or more user criteria; and
including the media item in the smart playlist if the determination is made to include the media item in the smart playlist; and
if there are multiple desired personalized metadata instances:
combining the multiple desired personalized metadata instances to provide a combined personalized metadata instance;
making a determination as to whether to include the media item in the smart playlist based on a comparison of the combined personalized metadata instance and the one or more user criteria; and
including the media item in the smart playlist if the determination is made to include the media item in the smart playlist.

9. The method of claim 1 wherein for each media item of the at least a subset of the plurality of media items, the personalized metadata for the media item comprises at least one of a group consisting of: a user rating, a last-played time stamp, and a score assigned to the media item as a function of user preferences.

10. The method of claim 1 wherein the smart playlist definition further comprises one or more media criteria.

11. The method of claim 1 wherein the smart playlist definition further comprises one or more playlist control criteria.

12. The method of claim 1 wherein the smart playlist definition further comprises one or more media criteria and one or more playlist control criteria, and populating the smart playlist comprises:
identifying a list of media items satisfying the one or more media criteria and the one or more user criteria from a pool of media items including the plurality of media items; and
filtering the list of media items based on the one or more playlist control criteria to provide the smart playlist.

13. The method of claim 1 wherein obtaining the smart playlist definition comprises enabling the user of the user device to provide the smart playlist definition.

14. The method of claim 1 wherein the smart playlist definition is a shared smart playlist definition comprising the one or more user criteria, and obtaining the smart playlist definition comprises receiving the smart playlist definition from a user device of one of the one or more sharing users.

15. The method of claim 14 wherein obtaining the smart playlist definition further comprises enabling the user of the user device to further define the one or more user criteria.

16. The method of claim 1 wherein the smart playlist definition is a shared smart playlist definition comprising one or more criteria but not the one or more user criteria, and obtaining the smart playlist definition comprises:
receiving the shared smart playlist definition comprising one or more criteria but not the one or more user criteria from a user device of one of the one or more sharing users; and
enabling the user to add the one or more user criteria to the shared smart playlist definition to provide the smart playlist definition.

17. A user device of a user comprising:
a communication interface communicatively coupling the user device to one or more user devices of corresponding one or more sharing users; and
a control system associated with the communication interface and adapted to:
obtain personalized metadata for each media item of at least a subset of a plurality of media items accessible to the user device via a media sharing system comprising the one or more user devices of the one or more sharing users hosting the plurality of media items and the user device of the user;
obtain a smart playlist definition, the smart playlist definition comprising one or more user criteria; and
populate a smart playlist based on a comparison of the one or more user criteria of the smart playlist definition and the personalized metadata for the at least a subset of the plurality of media items.

18. A computer readable medium comprising software for instructing a user device of a user to:
obtain personalized metadata for each media item of at least a subset of a plurality of media items accessible to the user device via a media sharing system comprising one or more user devices of one or more sharing users hosting the plurality of media items and the user device of the user;
obtain a smart playlist definition, the smart playlist definition comprising one or more user criteria; and
populate a smart playlist based on a comparison of the one or more user criteria of the smart playlist definition and the personalized metadata for the at least a subset of the plurality of media items.

19. The computer readable medium of claim 18 wherein for each media item of the at least a subset of the plurality of media items, the personalized metadata for the media item comprises a personalized metadata instance for the media item for the user of the user device.

20. The computer readable medium of claim 18 wherein for each media item of the at least a subset of the plurality of media items, the personalized metadata for the media item comprises a personalized metadata instance for the media item for at least one user other than the user of the user device.

21. The computer readable medium of claim 18 wherein for each media item of the at least a subset of the plurality of media items, the personalized metadata for the media item comprises a personalized metadata instance for the media item for at least one of a group consisting of: the user of the user device and at least one user other than the user of the user device.

22. The computer readable medium of claim 21 wherein the personalized metadata for at least one media item of the at least a subset of the plurality of media items comprises a personalized metadata instance for the user of the user device and a personalized metadata instance for at least one user other than the user of the user device

23. The computer readable medium of claim 22 wherein the smart playlist definition further comprises information defining an order of preference for personalized metadata instances of a plurality of users including the user of the user device and the at least one user other than the user of the user device.

24. The computer readable medium of claim 23 wherein in order to populate the smart playlist, the software is further adapted to instruct the user device to, for each media item in a pool of media items including the plurality of media items:
if the media item has personalized metadata associated therewith, identify a desired personalized metadata instance for the media item according to the order of preference for the personalized metadata instances for the plurality of users including the user of the user device and the at least one user other than the user of the user device;
make a determination as to whether to include the media item in the smart playlist based on a comparison of the desired personalized metadata instance and the one or more user criteria; and
include the media item in the smart playlist if the determination is made to include the media item in the smart playlist.

25. The computer readable medium of claim 23 wherein in order to populate the smart playlist, the software is further adapted to instruct the user device to, for each media item in a pool of media items including the plurality of media items:
if the media item has personalized metadata associated therewith, identify at least one desired personalized metadata instance for the media item according to the order of preference for the personalized metadata instances for the plurality of users including the user of the user device and the at least one user other than the user of the user device;
if there is only one desired personalized metadata instance:
make a determination as to whether to include the media item in the smart playlist based on a comparison of the desired personalized metadata instance and the user criteria; and
include the media item in the smart playlist if the determination is made to include the media item in the smart playlist; and
if there are multiple desired personalized metadata instances:
combine the more than one desired personalized metadata instances to provide a combined personalized metadata instance;
make a determination as to whether to include the media item in the smart playlist based on a comparison of the combined personalized metadata instance and the one or more user criteria; and
include the media item in the smart playlist if the determination is made to include the media item in the smart playlist.

26. The computer readable medium of claim 18 wherein for each media item of the at least a subset of the plurality of media items, the personalized metadata for the media item comprises at least one of a group consisting of: a user rating, a last-played time stamp, and a score assigned to the media item as a function of user preferences.
